(19) United States
(12) Patent Application Publication
(10) Pub. No.: US 2015/0130237 A1
(43) Pub. Date: May 14, 2015

(54) SEAT FOR MOVING BODY

(71) Applicants: Eishi Takeuchi, Nagoya-shi (JP); Kohshi Katoh, Hadano-shi (JP)

(72) Inventors: Eishi Takeuchi, Nagoya-shi (JP); Kohshi Katoh, Hadano-shi (JP)

(73) Assignee: TOYOTA JIDOSHA KABUSHIKI KAISHA, Toyota-shi (JP)

(21) Appl. No.: 14/395,908

(22) PCT Filed: Apr. 23, 2012
(86) PCT No.: PCT/JP2012/060875

§ 371 Date: Nov. 21, 2014

(51) Int. Cl. B60N 2/20; B60N 2/64; B60N 2/22

(52) U.S. Cl. CPC B60N 2/20; B60N 2/2222; B60N 2/64
USPC 297/301.1

(57) ABSTRACT

Disclosed is a seat for a vehicle including a seatback portion and a seat portion. The seatback portion includes a lower portion of the seatback portion that supports a lower part of an upper body of an occupant sitting in the seat portion, and an upper portion of the seatback portion that supports an upper part of the upper body. The lower portion of the seatback portion has support resistance against the lateral movement of the upper body, which is lower than that of the upper portion.

### TECHNICAL FIELD

The present invention relates to a seat for a moving body.

### BACKGROUND ART

In the related art, for example, Japanese Unexamined Patent Application Publication No. 2009-095465 discloses a seat for a vehicle, in which a fabric spring is provided in each of a backrest portion and a seat portion so as to improve comfort of an occupant.

### CITATION LIST

### Patent Literature

[Patent Literature 1] Japanese Unexamined Patent Application Publication No. 2009-095465

### SUMMARY OF INVENTION

### Technical Problem

For example, when a vehicle is turned, centrifugal force (lateral acceleration) is applied to the upper body of the occupant sitting in the seat portion. At this time, the upper body moves laterally toward the application direction of the centrifugal force, and rolls considerably about a contact point between the upper body and the seat portion. For this reason, the occupant maintains the stability of the upper body by remaining firm using the lower body or pushing the upper body (the back of the upper body) against the backrest portion. However, the lateral movement of the upper body increases, and it is difficult to prevent the rolling.

The present invention provides a seat for a moving body which can effectively prevent the rolling of the upper body of an occupant.

### Solution to Problem

According to the present invention, there is provided a seat for a moving body including a backrest portion; and a seat portion. The backrest portion includes a lower backrest portion that supports a lower part of the upper body of an occupant sitting in the seat portion, and an upper backrest portion that supports an upper part of the upper body. The lower backrest portion has support resistance against the lateral movement of the upper body, which is lower than that of the upper backrest portion.

For example, when the vehicle is turned, centrifugal force is applied to the upper part of the upper body of the occupant with the vicinity of the scapula as the center of gravity, and turning momentum occurs about a contact point between the upper body and the seat portion. Accordingly, as the contact position of the upper body with respect to the backrest portion increases further, it is possible to secure a large reaction force against centrifugal force and turning momentum associated with the centrifugal force. In the seat for a moving body according to the present invention, the lower backrest portion has support resistance against the lateral movement of the upper body, which is lower than that of the upper backrest portion. For this reason, it is possible to secure a large reaction force against centrifugal force and turning momentum associated with the centrifugal force, and it is possible to effectively prevent the lateral movement and rolling of the upper body.

Here, for example, the backrest portion can have the following configuration. That is, the lower backrest portion may have a cushion portion formed by a plurality of block members that line up at least in a lateral movement direction while being separate from each other. The lower backrest portion may have a cushion portion in which gaps are formed in a direction intersecting the lateral movement direction. The lower backrest portion may be made of a material having resistance against transformation associated with the lateral movement, which is lower than that of the upper backrest portion.

Each of the upper and lower backrest portions may have a plurality of air cushions. The air cushions of the upper backrest portion may line up in a direction intersecting the lateral movement direction, and the air cushions of the lower backrest portion may line up to be parallel with each other in the lateral movement direction. Each of the upper and lower backrest portions may have a surface fabric. The surface fabric of the upper backrest portion may be stitched to have seams formed in a direction intersecting the lateral movement direction, and the surface fabric of the lower backrest portion may be stitched to have seams formed in parallel with the lateral movement direction. The lower backrest portion may have a cushion portion that is supported to have mobility in the lateral movement direction, which is greater than that of a cushion portion of the upper backrest portion.

The seat portion of the seat for a moving body preferably includes a sitting surface portion that is transformed or displaced in such a manner that the lower part of the upper body is inclined in the lateral movement direction when the upper body moves laterally. Accordingly, when the upper body moves laterally, the sitting surface portion is transformed or displaced in such a manner that the lower part of the upper body is inclined in the lateral movement direction. Accordingly, when the lower part of the upper body is inclined, contrary to the inclination, the upper part of the upper body is naturally inclined toward an opposite direction of the lateral movement direction. As a result, the upper body is naturally pushed against the upper backrest portion, and it is possible to more effectively prevent the rolling of the upper body. In particular, since the upper part of the upper body is inclined toward the opposite direction of the lateral movement direction, it is possible to effectively prevent the rolling of a head part of the occupant, and prevent the occurrence of carsickness symptoms or the like.

The sitting surface portion of the seat for a moving body is preferably transformed or displaced about an imaginary turning axis that is positioned at the height of the lower part of the upper body and has an axis in a rolling direction of the moving body. Accordingly, when the upper body moves laterally, the upper body of the occupant is naturally inclined about the lower part of the upper body.

Here, for example, the seat portion can have the following configuration. That is, the seat portion may have a support body that has right and left end portions and supports the sitting surface portion, and a turning support portion, one end of which is supported to be able to turn about a support end positioned above each of the right and left end portions, and the other end of which is supported to be able to turn about each of the end portions. Right and left end portions of the sitting surface portion may be supported in order for the sitting surface portion to be able to turn in the lateral movement direction. Right and left end portions of the sitting surface portion may be elastically supported in order for the sitting surface portion to be able to turn in the lateral movement direction. Front and rear end portions of the sitting surface portion may be supported in order for the sitting surface portion to be able to swing in the lateral movement direction. The seat portion may have a support body that supports the sitting surface portion, and a support portion which extends in a lateral direction of the seat portion and by which the support body is supported to be able to swing in the lateral movement direction.

### Advantageous Effects of Invention

The present invention can provide a seat for a moving body that can effectively prevent the rolling of the upper body of an occupant.

### BRIEF DESCRIPTION OF DRAWINGS

FIG. 1 is a perspective view illustrating a seat for a vehicle according to an embodiment of the present invention.

FIG. 2 is a schematic view illustrating the operational principle of the seat for a vehicle.

FIG. 3 is a perspective view illustrating a seatback portion according to a first embodiment.

FIG. 4 is a cross-sectional view taken along cross section U-U and cross section L-L in FIG. 1 illustrating a seatback portion according to a second embodiment.

FIG. 5 is a cross-sectional view taken along cross section U-U and cross section L-L in FIG. 1 illustrating a seatback portion according to a modification example of the second embodiment.

FIG. 6 is a cross-sectional view taken along cross section U-U and cross section L-L in FIG. 1 illustrating a seatback portion according to another modification example of the second embodiment.

FIG. 7 is a schematic view illustrating a seatback portion according to a third embodiment.

FIG. 8 is a schematic view illustrating a seatback portion according to a fourth embodiment.

FIG. 9 is a schematic view illustrating a seatback portion according to a fifth embodiment.

FIG. 10 is a schematic view illustrating a seatback portion according to a sixth embodiment.

FIG. 11 is a schematic view illustrating a seat portion according to a first embodiment.

FIG. 12 is a schematic view illustrating a seat portion according to a second embodiment.

FIG. 13 is a schematic view illustrating a modification example of a seat portion according to a modification example of the second embodiment.

FIG. 14 is a schematic view illustrating a seat portion according to a third embodiment.

FIG. 15 is a schematic view illustrating a seat portion according to a fourth embodiment.

FIG. 16 is a schematic view illustrating a seat portion according to a fifth embodiment.

### DESCRIPTION OF EMBODIMENTS

Hereinafter, embodiments of the present invention will be described in detail with reference to the accompanying drawings. In the description of the drawings, the same reference signs are assigned to the same elements, and the description thereof will be omitted.

In the following example, a seat for a moving body of the present invention is applied to a seat for a vehicle. However, the seat for a moving body can be applied to not only the seat for a vehicle, but also a seat for other moving bodies such as a streetcar and an airplane in a similar way.

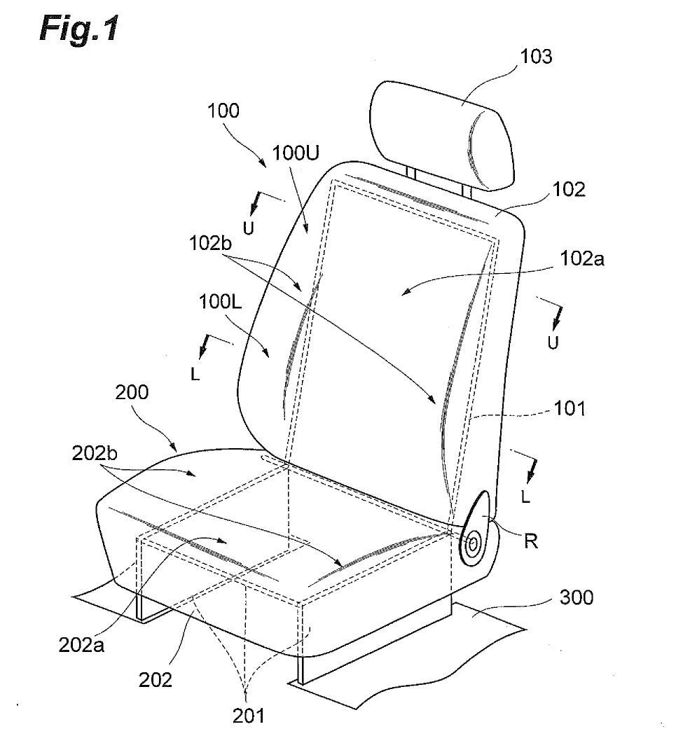

First, the basic configuration of the seat for a vehicle according to the embodiment of the present invention will be described with reference to FIG. 1. FIG. 1 is a perspective view illustrating the seat for a vehicle according to the embodiment of the present invention. Since the structure of a seatback portion (backrest portion) 100 and a seat portion 200 is improved, the seat for a vehicle (seat for a moving body) can effectively prevent the rolling of the upper body of an occupant.

As illustrated in FIG. 1, the seat for a vehicle includes the seatback portion 100 and the seat portion 200. The seat for a vehicle includes a seatback frame 101 and a seat frame 201. The seatback frame 101 is supported by the seat frame 201, and the seat frame 201 is supported by the structure of a lower vehicle body portion such as a floor panel 300.

The seatback frame 101 and a seatback cushion 102 form the seatback portion 100, and the seat frame 201 and a seat cushion 202 form the seat portion 200. The seatback portion 100 is held in order for the seatback portion 100 to be able to turn about the seat portion 200 via a reclining mechanism R.

In the seatback cushion 102, side supports 102b are respectively formed on both sides of a backrest 102a in a lateral direction of the backrest 102a, and extend forward further than the backrest 102a. A head rest 103 is provided above the seatback cushion 102. In the seat cushion 202, side supports 202b are respectively formed on both sides of a flat portion 202a in a lateral direction of the flat portion 202a, and protrude upward from the flat portion 202a.

The seatback cushion 102 is provided with a front cover, a back cover, and a cushion portion which will be described later. The cushion portion is covered with the front and back covers, and the front cover is in contact with the back of the occupant sitting in the seat portion. The front and back covers are made of a textile fabric, a resin fabric, leather, or the like. The cushion portion is a shock absorbing portion for absorbing impact applied to the upper body of the occupant. The cushion portion is made of urethane, an air cushion, elastomer resin, or the like. A back base fabric, a spring, and the like may be provided between the back cover and the cushion portion.

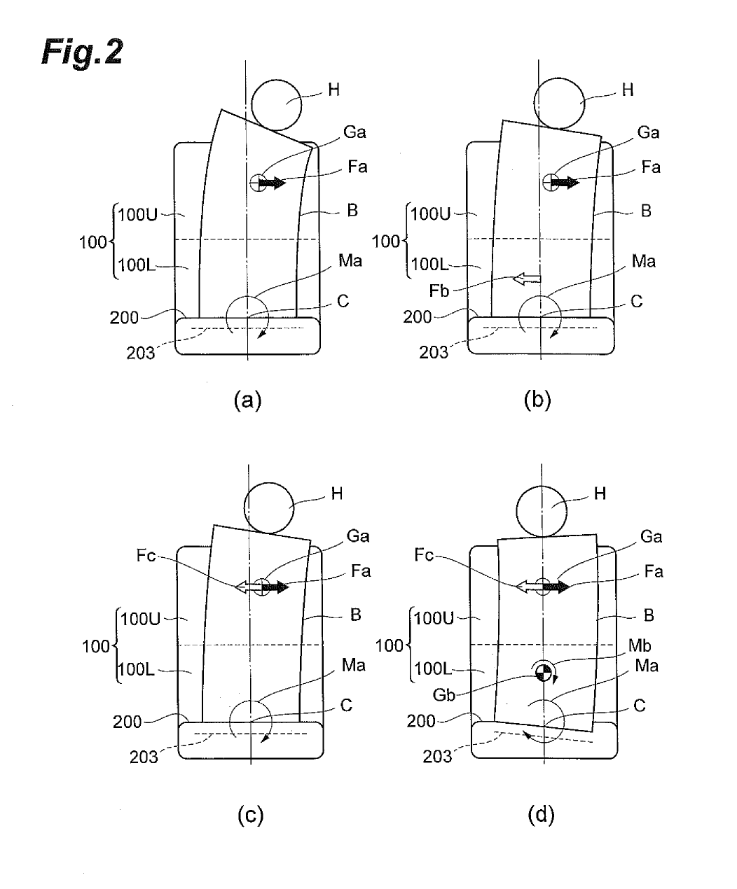

The seatback portion 100 is divided into an upper portion 100U (upper backrest portion) and a lower portion 100L (lower backrest portion). The upper portion 100U supports an upper part of the upper body of the occupant sitting in the seat portion 200, particularly, in the vicinity of the scapula. The lower portion 100L supports a lower part of the upper body of the occupant, particularly, in the vicinity of the waist. Accordingly, the lower portion 100L of the seatback portion 100 supports the lower part of the upper body of the occupant sitting in the seat portion 200, and the upper portion 100U of the seatback portion 100 supports the upper part of the upper body of the occupant. The seat portion 200 has a sitting surface portion 203 (refer to FIG. 2) that supports the flat portion 202a of the seat cushion 202. The sitting surface portion 203 supports the buttocks and femoral regions of the occupant sitting in the seat portion 200.

Subsequently, the operational principle of the seat for a vehicle according to the embodiment of the present invention will be described with reference to FIG. 2. FIG. 2 is a schematic view illustrating the operational principle of the seat for a vehicle.

As illustrated in FIG. 2(a), for example, when the vehicle is turned, centrifugal force Fa is applied to the upper part of the upper body B of the occupant, with the vicinity of the scapula as the center of gravity Ga, and turning momentum Ma occurs about a contact point C between the occupant and the seat portion 200. The upper body B moves laterally toward the application direction of the centrifugal force Fa, and rolls considerably about the contact point C between the occupant and the seat portion 200.

Here, as illustrated in FIG. 2(b), it is assumed that the occupant pushes the upper body B against the lower portion 100L of the seatback portion 100 so as to maintain the stability of the upper body B. At this time, since the contact position of the upper body B with respect to the seatback portion 100 is lower than the center of gravity Ga of the upper body B, it may not be possible to secure a large reaction force Fb against the centrifugal force Fa and the turning momentum Ma associated with the centrifugal force Fa. As a result, when the occupant does not strongly remain firm using the lower body, or strongly push the upper body B against the lower portion 100L of the seatback portion 100, the occupant may not be able to prevent the rolling of the upper body B.

Subsequently, as illustrated in FIG. 2(c), it is assumed that the occupant brings the upper body B into contact with the upper portion 100U of the seatback portion 100 so as to maintain the stability of the upper body B. At this time, since the contact position of the upper body B with respect to the seatback portion 100 is close to the center of gravity of the upper body B, it is possible to secure a relatively large reaction force Fc against the centrifugal force Fa and the turning momentum Ma associated with the centrifugal force Fa.

As illustrated in FIG. 2(d), it is assumed that in the state illustrated in FIG. 2(c), the occupant turns the lower part of the upper body B toward the application direction of the centrifugal force Fa, that is, a lateral movement direction (right direction in FIG. 2). At this time, when the lower part of the upper body B is inclined, contrary to the inclination, the upper part of the upper body B is naturally inclined toward an opposite direction (left direction in FIG. 2) of the lateral movement direction.

In the seat for a vehicle according to the embodiment of the present invention, the lower portion 100L of the seatback portion 100 is formed to have support resistance against the lateral movement of the occupant, which is lower than that of the upper portion 100U of the seatback portion 100. For this reason, it is possible to secure the large reaction force Fc against the centrifugal force Fa and the turning momentum Ma associated with the centrifugal force Fa, and it is possible to effectively prevent the lateral movement and rolling of the upper body B.

In the seat for a vehicle according to the embodiment of the present invention, the seat portion 200 includes the sitting surface portion 203 that is transformed or displaced to incline the lower part of the upper body B toward the lateral movement direction. When the lower part of the upper body B is inclined, contrary to the inclination, the upper part of the upper body B is naturally inclined toward the opposite direction of the lateral movement direction. For this reason, the upper body B is naturally pushed against the upper portion 100U of the seatback portion 100, and it is possible to more effectively prevent the rolling of the upper body B. In particular, since the upper part of the upper body B is inclined toward the opposite direction of the lateral movement direction, it is possible to effectively prevent the rolling of a head part H of the occupant, and prevent the occurrence of carsickness symptoms or the like.

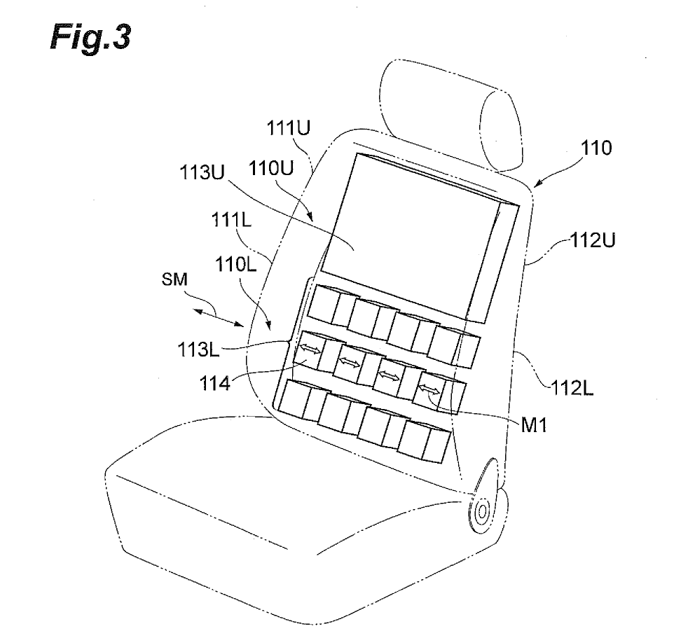

Subsequently, first to sixth embodiments of the seatback portion 100 of the seat for a vehicle will be described with reference to FIGS. 3 to 10. As illustrated in FIG. 2, the lower portion 100L of the seatback portion 100 has support resistance against the lateral movement of the upper body, which is lower than that of the upper portion 100U of the seatback portion 100.

FIG. 3 is a perspective view illustrating a seatback portion 110 according to the first embodiment. In the seatback portion 110 according to the first embodiment, a lower portion 110L of the seatback portion 110 has a cushion portion 113L formed by a plurality of block members 114 that line up at least in a lateral movement direction SM while being separate from each other.

An upper portion 110U of the seatback portion 110 is provided with a front cover 111U, a back cover 112U, and a cushion portion 113U. The lower portion 110L is also provided with a front cover 111L, a back cover 112L, and the cushion portion 113L. The cushion portions 113U and 113L are made of urethane, elastomer resin, or the like.

Here, the cushion portion 113U of the upper portion 110U is formed by a single block. In contrast, the cushion portion 113L of the lower portion 110L is formed by the plurality of small blocks 114, each of which has a columnar shape, a prismatic shape, or the like, and which are arranged to line up in a lateral direction and a vertical direction of the seatback portion 110. Accordingly, the cushion portion 113L of the lower portion 110L is relatively likely to be transformed compared to the cushion portion 113U of the upper portion 110U in a lateral direction (direction of arrow M1) of the cushion portion 113L, and has low rigidity.

In the example illustrated in FIG. 3, the blocks of the cushion portion 113L of the lower portion 110L are arranged in four rows laterally and three rows vertically, however, other block arrangements may be applied. Insofar as the transformation of the cushion portion 113U of the upper portion 110U is unlikely to be transformed compared to the cushion portion 113L of the lower portion 110L, the cushion portion 113U may be formed by a plurality of blocks. Each of the blocks 114 of the lower portion 110L may have a compression resistant member (not illustrated) such as a thin plate that is provided in a thickness direction of the cushion portion 113L so as to provide enough compression resistance to support the upper body.

In the seatback portion 110 according to the first embodiment, the lower portion 110L of the seatback portion 110 has the cushion portion 113L formed by the plurality of block members 114 that line up at least in the lateral movement direction SM while being separate from each other. Accordingly, the elastic resistance of the lower portion 110L of the seatback portion 110 is reduced to be lower than that of the upper portion 110U of the seatback portion 110 via the arrangement structure of the block members 114. For this reason, in the seatback portion 110, the lower portion 110L has support resistance against the lateral movement of the upper body, which is lower than that of the upper portion 110U.

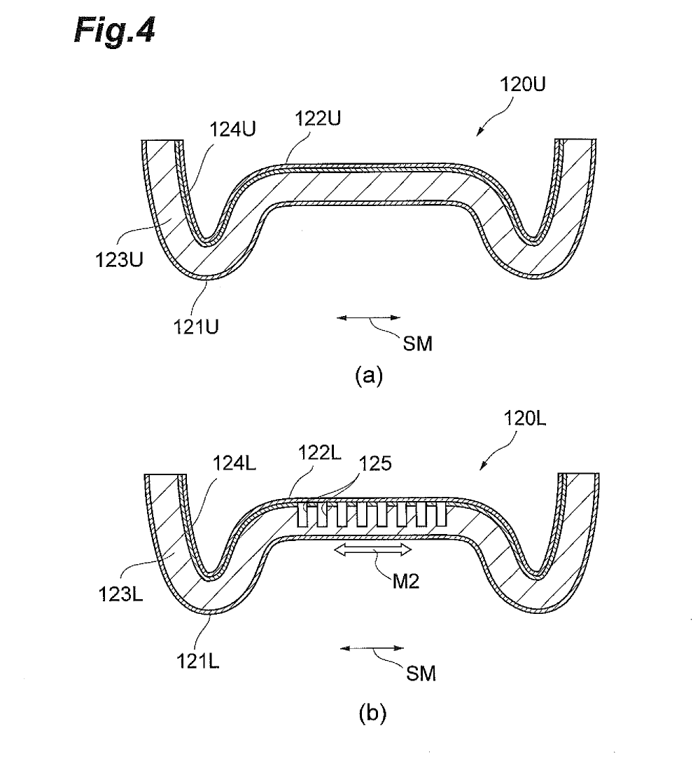

FIGS. 4 to 6 are cross-sectional views taken along cross section U-U and cross section L-L in FIG. 1, illustrating a seatback portion 120 according to the second embodiment and seatback portions 130 and 140 according to modification examples of the second embodiment. In the seatback portions 120, 130, and 140 according to the second embodiment and the modification examples of the second embodiment, lower portions 120L, 130L, 140L of the seatback portions 120, 130, and 140 have cushion portions 123L, 133L, 143L in which gaps 125, 135, and 145 are formed in a direction intersecting the lateral movement direction SM, respectively. Hereinafter, the seatback portion 120 according to the second embodiment will be mainly described.

As described in FIG. 4, an upper portion 120U of the seatback portion 120 is provided with a front cover 121U, a back cover 122U, and a cushion portion 123U. The lower portion 120L is also provided with a front cover 121L, a back cover 122L, and the cushion portion 123L. For example, the cushion portions 123U and 123L are made of urethane.

Here, a plurality of the grooves (gaps) 125 are formed in the substantially vertical direction along a back surface of the cushion portion 122L of the lower portion 120L. The grooves 125 may be formed when or after the cushion portion 123L is molded. Accordingly, the cushion portion 123L of the lower portion 120L is relatively likely to be transformed in the lateral direction (direction of arrow M2) compared to the cushion portion 123U of the upper portion 120U. The cushion portion 122U of the upper portion 120U may be provided with the grooves insofar as the cushion portion 122U satisfies the transformation condition, and a plurality of the grooves 125 may be inclined. In addition, the grooves 125 may be formed in the cushion portion 123L and a back base fabric 124L.

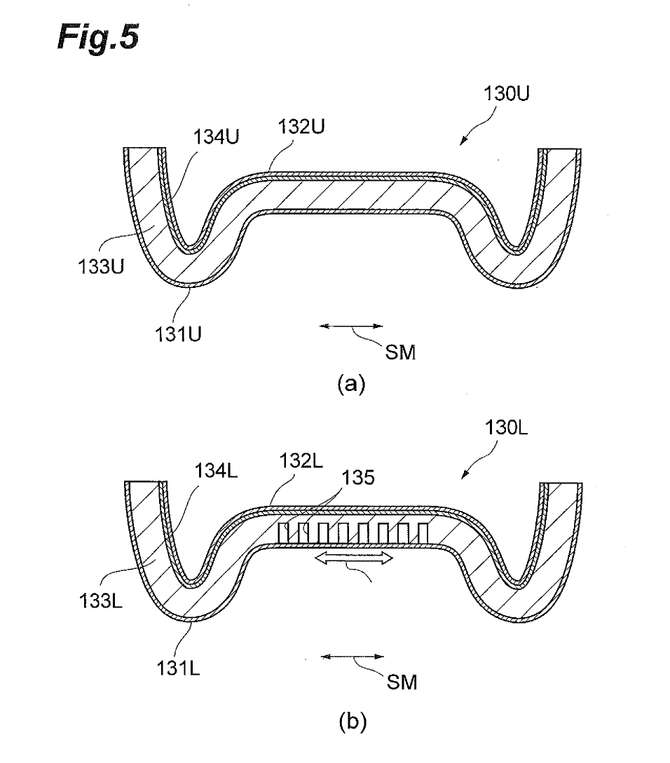

Unlike the seatback portion 120 illustrated in FIG. 4, in the lower portion 130L of the seatback portion 130 illustrated in FIG. 5, a plurality of the grooves (gaps) 135 are formed in the substantially vertical direction along a front surface of a cushion portion 133L.

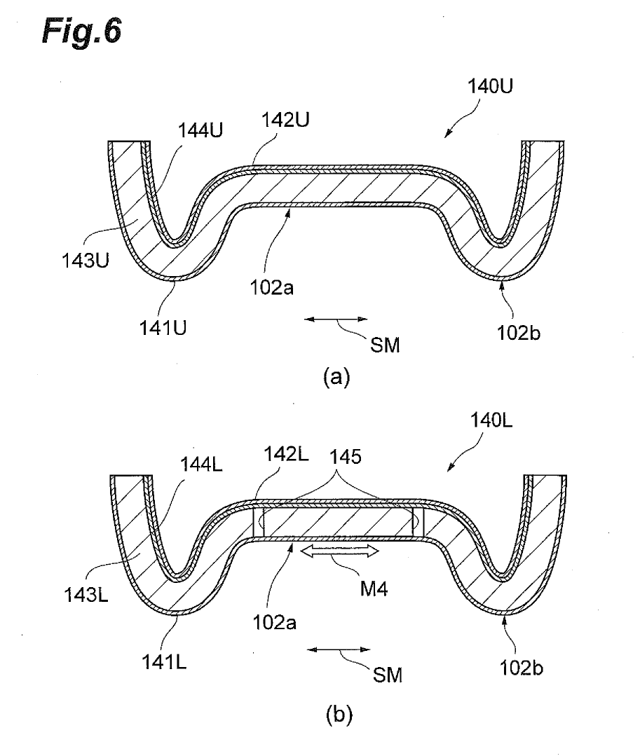

Unlike the seatback portion 120 illustrated in FIG. 4, in the lower portion 140L of the seatback portion 140 illustrated in FIG. 6, the gaps 145 are formed between the backrest 102a and the side supports 102b. The gaps 145 are formed by making the width of an upper portion smaller than that of a lower portion of the backrest 102a or the side supports 102b, or adjusting a mounting position between the upper and lower portions.

Accordingly, a cushion portion 143L of the lower portion 140L is relatively likely to be transformed or displaced in the lateral direction (direction of arrow M4) compared to a cushion portion 143U of the upper portion 140U, and the rigidity of the cushion portion 143L decreases. A cushion portion 143U of the upper portion 140U may also be provided with the gaps insofar as the cushion portion 143U satisfies the transformation or displacement condition.

In the seatback portions 120, 130, and 140 according to the second embodiment and the modification examples of the second embodiment, the lower portions 120L, 130L, and 140L of the seatback portions 120, 130, and 140 have the cushion portions 123L, 133L, and 143L in which the gaps 125, 135, and 145 are formed to be substantially perpendicular to the lateral movement direction SM, respectively. Accordingly, in the seatback portion 120, 130, and 140, the elastic resistance or displacement resistance of the lower portions 120L, 130L, and 140L is reduced to be lower than that of the upper portions 120U, 130U, and 140U by virtue of the formation of the gaps 125, 135, and 145, respectively. For this reason, in the seatback portions 120, 130, and 140, the lower portions 120L, 130L, and 140L have support resistance against the lateral movement of the upper body, which is lower than that of the upper portions 120U, 130U, and 140U, respectively.

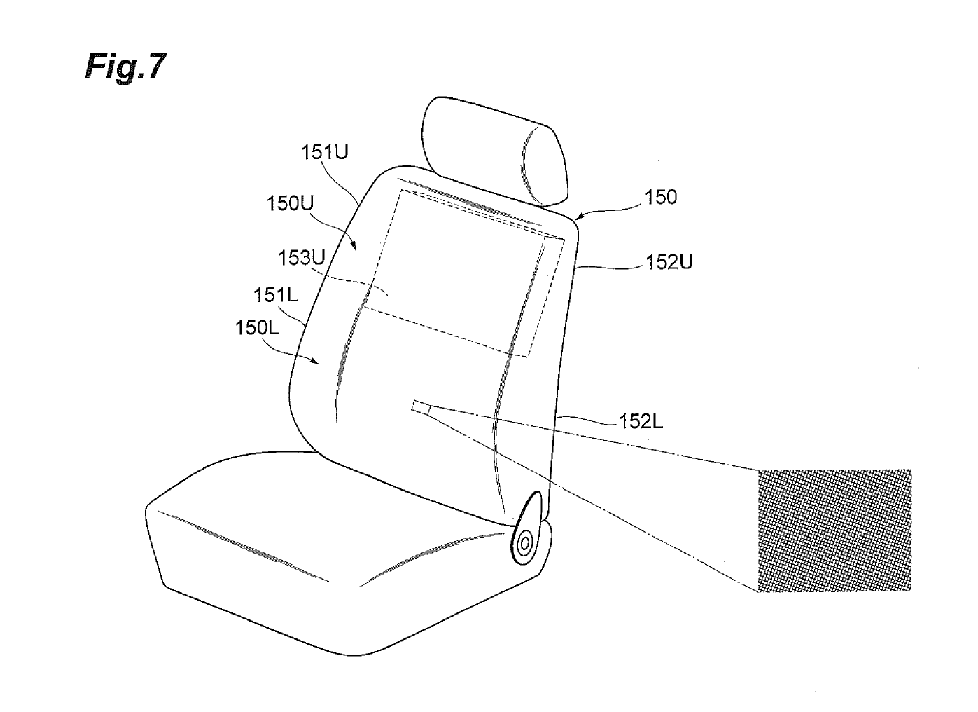

FIG. 7 is a schematic view illustrating a seatback portion 150 according to the third embodiment. According to the third embodiment, a lower portion 150L of the seatback portion 150 is made of a material having resistance against transformation associated with a lateral movement, which is lower than that of an upper portion 150U of the seatback portion 150.

The upper portion 150U of the seatback portion 150 is provided with a front cover 151U, a back cover 152U, and a cushion portion 153U. In contrast, the lower portion 150L is provided with a front cover 151L and a back cover 152L, but not provided with a cushion portion. In the example illustrated in FIG. 7, in particular, the cushion portion 153U of the upper portion 150U is made of urethane, and the front cover 151L of the lower portion 150L is formed by a net cover.

Accordingly, the upper portion 150U resists the lateral movement of the upper body by virtue of the frictional resistance of the front cover 151U and the elastic resistance of the cushion portion 153U. In contrast, the lower portion 150L resists the lateral movement of the upper body by virtue of the frictional resistance of the front cover 151L, and the rigidity of the lower portion 150L decreases. Accordingly, in particular, since the front cover 151L of the lower portion 150L is formed by a net cover, it is possible to reduce the frictional resistance of the front cover 151L.

In the seatback portion 150 according to the third embodiment, the lower portion 150L (the front cover 151L) is made of a material having resistance against transformation associated with a lateral movement, which is lower than that of the upper portion 150U (the cushion portion 153U). Accordingly, in the seatback portion 150, the elastic resistance and the frictional resistance of the lower portion 150L is reduced to be lower than those of the upper portion 150U by virtue of the characteristics of the material. For this reason, in the seatback portion 150, the lower portion 150L has support resistance against the lateral movement of the upper body, which is lower than that of the upper portion 150U.

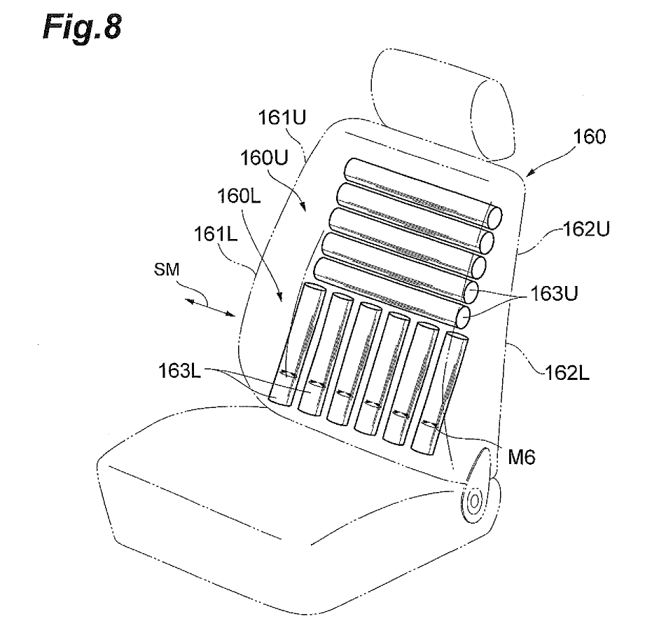

FIG. 8 is a schematic view illustrating a seatback portion 160 according to the fourth embodiment. In the seatback portion 160 according to the fourth embodiment, each of an upper portion 160U and a lower portion 160L has a plurality of air cushions 163U and 163L. The air cushions 163U of the upper portion 160U line up in a direction intersecting the lateral movement direction SM, and the air cushions 163L of the lower portion 160L line up to be parallel with each other in the lateral movement direction SM.

The upper portion 160U of the seatback portion 160 is provided with a front cover 161U, a back cover 162U, and the cushion portion 163U. The lower portion 160L is also provided with a front cover 161L, a back cover 162L, and the cushion portion 163L. The cushion portions 163U and 163L are formed by a plurality of air cushions, each of which has a columnar shape, a polygonal prismatic shape, or the like, and is charged with gas such as air.

Here, the air cushions 163U of the upper portion 160U are disposed to be parallel with each other in a vertical direction of the seatback portion 160, and in contrast, the air cushions 163L of the lower portion 160L are disposed to be parallel with each other in a lateral direction of the seatback portion 160. Accordingly, the air cushions 163L of the lower portion 160L are relatively likely to turn and be transformed in the lateral direction (direction of arrow M6) compared to the air cushions 163U of the upper portion 160U, and the rigidity of the air cushions 163L decreases. In the example illustrated in FIG. 8, the upper air cushions 163U and the lower air cushions 163L are arranged in four rows and six rows, respectively, however, other cushion arrangements may be applied. Insofar as the air cushions 163U and 163L satisfy the transformation condition, the air cushions 163U and 163L may be disposed diagonally with respect to the seatback portion 160.

In the seatback portion 160 according to the fourth embodiment, the upper portion 160U and the lower portion 160L have the plurality of air cushions 163U and 163L, respectively, the air cushions 163U of the upper portion 160U line up in the direction intersecting the lateral movement direction SM, and the air cushions 163L of the lower portion 160L line up to be parallel with each other in the lateral movement direction SM. Accordingly, in the seatback portion 160, the elastic resistance or transformation resistance of the lower portion 160L is reduced to be lower than that of the upper portion 160U by virtue of the arrangement structure of the air cushions 163U and 163L. For this reason, in the seatback portion 160, the lower portion 160L has support resistance against the lateral movement of the upper body, which is lower than that of the upper portion 160U.

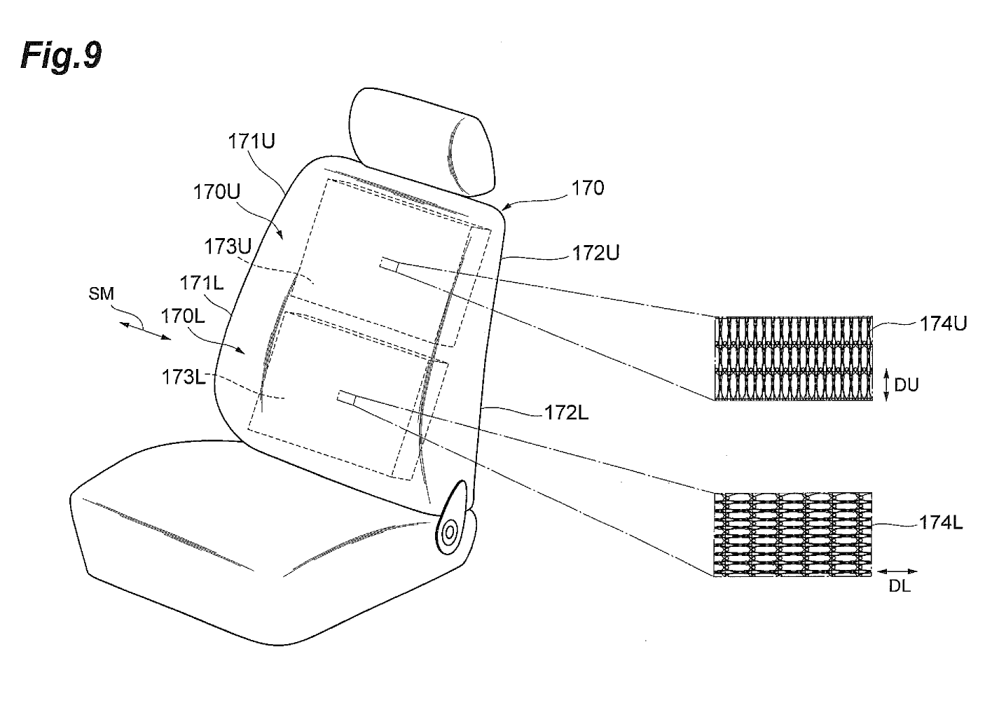

FIG. 9 is a schematic view illustrating a seatback portion 170 according to the fifth embodiment. According to the fifth embodiment, an upper portion 170U and a lower portion 170L of the seatback portion 170 have surface fabrics (surface covers 171U and 171L), respectively. The surface fabric (the surface cover 171U) of the upper portion 170U is stitched to have seams 174U formed in the direction intersecting the lateral movement direction SM, and the surface fabric (the surface fabric 171L) of the lower portion 170L is stitched to have seams 174L formed in parallel with the lateral movement direction SM.

The upper portion 170U of the seatback portion 170 is provided with the front cover 171U, a back cover 172U, and a cushion portion 173U. The lower portion 170L is also provided with the front cover 171L, a back cover 172L, and a cushion portion 173L. The front covers 171U and 171L are made of a stitched textile fabric.

Here, the front cover 171U of the upper portion 170U is stitched to have the seams 174U formed in a direction intersecting a lateral direction of the seatback portion 170, in particular, in a substantially vertical direction DU, and in contrast, the front cover 171L of the lower portion 170L is stitched to have the seams 174L formed in a direction DL that is parallel with the lateral direction of the seatback portion 170. Accordingly, the front cover 171L of the lower portion 170L has frictional resistance in the lateral direction, which is lower than that of the front cover 171U of the upper portion 170U. Insofar as the respective seams 174U and 174L of the front covers 171U and 171L satisfy the frictional condition, the seams 174U and 174L may be inclined with respect to the lateral direction of the seatback portion 170.

In the seatback portion 170 according to the fifth embodiment, the upper portion 170U and the lower portion 170L have the surface fabrics (the surface covers 171U and 171L), respectively. The surface fabric (the surface fabric 171U) of the upper portion 170U is stitched to have the seams 174U formed in the direction intersecting the lateral movement direction SM, and the surface fabric (the surface cover 171L) of the lower portion 170L is stitched to have the seams 174L formed in parallel with the lateral movement direction SM. Accordingly, the frictional resistance of the lower portion 170L of the seatback portion 170 is reduced to be lower than that of the upper portion 170U by virtue of the surface structure of the surface fabric (the surface covers 171U and 171L). For this reason, in the seatback portion 170, the lower portion 170L has support resistance against the lateral movement of the upper body, which is lower than that of the upper portion 170U.

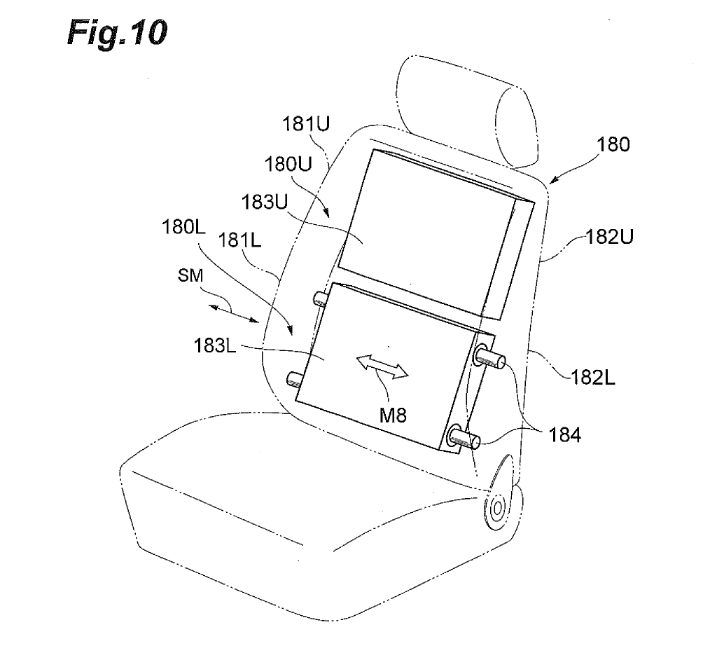

FIG. 10 is a schematic view illustrating a seatback portion 180 according to the sixth embodiment. According to the sixth embodiment, a lower portion 180L of the seatback portion 180 is supported to have mobility in the lateral movement direction SM, which is greater than that of an upper portion 180U of the seatback portion 180.

The upper portion 180U of the seatback portion 180 is provided with a front cover 181U, a back cover 182U, and a cushion portion 183U. The lower portion 180L is provided with a front cover 181L, a back cover 182L, and a cushion portion 183L.

Here, the cushion portion 183U of the upper portion 180U is fixed to a seatback frame (not illustrated). In contrast, the cushion portion 183L of the lower portion 180L is supported by a seatback frame (not illustrated) via support shafts 184 or the like in a state in which the cushion portion 183L is slightly slidable in a lateral direction of the seatback portion 180. Accordingly, the cushion portion 183L of the lower portion 180L is likely to be displaced in the lateral direction (direction of arrow M8) compared to the cushion portion 183U of the upper portion 180U. Insofar as the cushion portion 183U of the upper portion 180U is unlikely to be displaced compared to the cushion portion 183L of the lower portion 180L, the cushion portion 183U may also be supported in a state of being slidable.

In the seatback portion 180 according to the sixth embodiment, the lower portion 180L is supported to have mobility in the lateral movement direction SM, which is greater than that of the upper portion 180U. Accordingly, in the seatback portion 180, the displacement resistance of the lower portion 180L is reduced to be lower than that of the upper portion 180U by virtue of the support structure of the lower portion 180L. For this reason, in the seatback portion 180, the lower portion 180L has support resistance against the lateral movement of the upper body, which is lower than that of the upper portion 180U.

As described above, in the seatback portions 110, 120, 130, 140, 150, 160, 170, and 180 according to the embodiments of the present invention, the lower portions 110L, 120L, 130L, 140L, 150L, 160L, 170L, and 180L have support resistance against the lateral movement of the upper body, which is lower than that of the upper portions 110U, 120U, 130U, 140U, 150U, 160U, 170U, and 180U, respectively. For this reason, it is possible to secure a large reaction force against the centrifugal force and turning momentum associated with the centrifugal force, and it is possible to effectively prevent the lateral movement and rolling of the upper body.

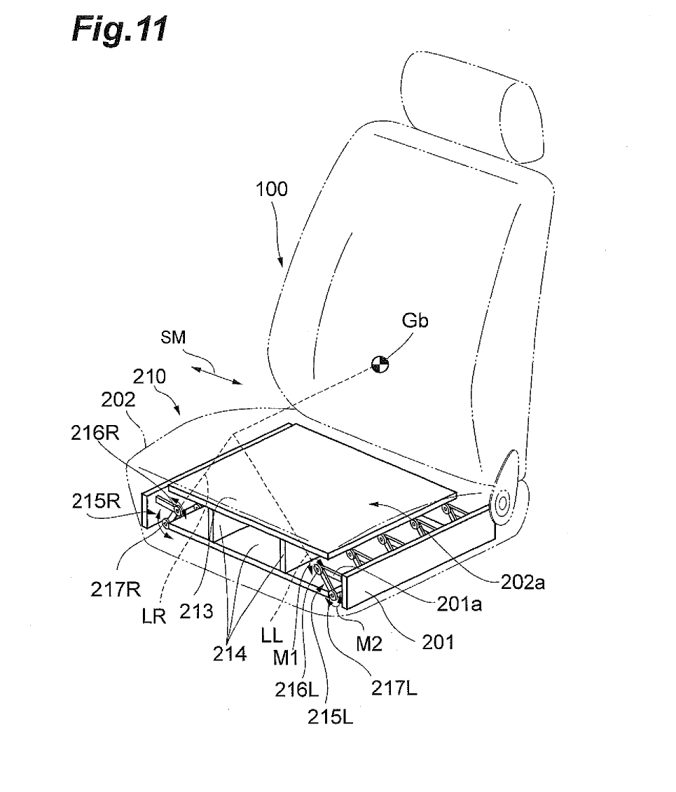

Subsequently, first to fifth embodiments of the seat portion 200 of the seat for a vehicle will be described with reference to FIGS. 11 to 16. As illustrated in FIG. 2, the seat portion 200 includes the sitting surface portion 203 that is transformed or displaced in order for the lower part of the upper body to be inclined in the lateral moving direction when the upper body moves laterally.

FIG. 11 is a schematic view illustrating a seat portion 210 according to the first embodiment. The seat portion 210 according to the first embodiment has a support body (sitting surface support portion 214) and a turning support portion 215. Here, the support body has right and left end portions, and supports a sitting surface portion 213, and one end of the turning support portion 215 is supported to be able to turn about a support end positioned above each of the right and left end portions, and the other end is supported to be able to turn about each of the end portions.

The seat portion 210 is provided with the sitting surface portion 213, the sitting surface support portion 214, and the turning support portion 215 (right support portion 215R and left support portion 215L). The sitting surface support portion 214 functions as a support body that supports the sitting surface portion 213. The sitting surface portion 213 is a member that supports the seat cushion 202, and is provided below the flat portion 202a of the seat cushion 202. The sitting surface portion 213 may be a belt-like spring (fabric spring or the like), a wire-like spring (S spring, contour spring, or the like), or the combination thereof.

The sitting surface support portion 214 is a rigid member that supports the sitting surface portion 213 upwardly. For example, the sitting surface support portion 214 is a member, the lateral cross section of which is an inverse it shape in the lateral direction of the seat portion 210.

The turning support portion 215 is a member by which the sitting surface support portion 214 is supported to be able to turn (swing) about the seat frame 201. The turning support portion 215 is a member that has first turning ends 216R and 216L with respect to the seat frame 201, and second turning ends 217R and 217L with respect to the sitting surface support portion 214. The turning support portion 215 has the right support portion 215R and the left support portion 215L. Here, the right support portion 215R supports a right end portion of the sitting surface support portion 214 with respect to the right seat frame 201, and the left support portion 215L supports a left end portion of the sitting surface support portion 214 with respect to the left seat frame 201.

The right support portion 215R and the left support portion 215L of the turning support portion 215 are respectively positioned below support points (points at which the first turning ends 216R and 216L are supported) provided at the tips of extending portions 201a of the seat frame 200. Accordingly, the turning support portion 215 turns about the support points via the first turning ends 2168 and 216L in the direction of arrow M1, and the sitting surface support portion 214 turns about the turning support portion 215 via the second turning ends 217R and 217L in the direction of arrow M2. Accordingly, the sitting surface portion 213 is supported to be able to swing about the seat frame 201 in the lateral movement direction SM via the first turning ends 216R and 216L and the second turning ends 217R and 217L of the turning support portion 215.

Here, the seat portion 210 has the following positional relationship with respect to the occupant sitting in the seat portion 210. That is, the turning support portion 215 is configured in such a manner that the position of an imaginary turning axis substantially coincides with the height of the vicinity of the lumbar vertebra of the occupant, in which the imaginary turning axis has an axis in a rolling direction of the moving body. The imaginary turning axis is an axis obtained by connecting an intersection point between line LL and line LR, and a position Gb. Line LL extends through the first turning end 216L from the left second turning end 217L, line LR extends through the first turning end 216R from the right second turning end 217R, and the position Gb is a position obtained by projecting the intersection point to the seatback portion 100. This positional relationship is maintained even when the sitting surface portion 213 swings via the first turning ends 216R and 216L and the second turning ends 217R and 217L, and the upper body is inclined laterally.

The seat portion 210 according to the first embodiment has the support body (the sitting surface support portion 214) and the turning support portion 215. Here, the support body has the right and left end portions, and supports the sitting surface portion 213, and one end (the first turning ends 216R and 216R) of the turning support portion 215 is supported to be able to turn about the support end positioned above each of the right and left end portions, and the other end (the second turning ends 217R and 217L) is supported to be able to turn about each of the end portions. For this reason, the sitting surface portion 213 is displaced in such a manner that the lower part of the upper body is inclined in the rolling direction of the vehicle, that is, the lateral movement direction SM.

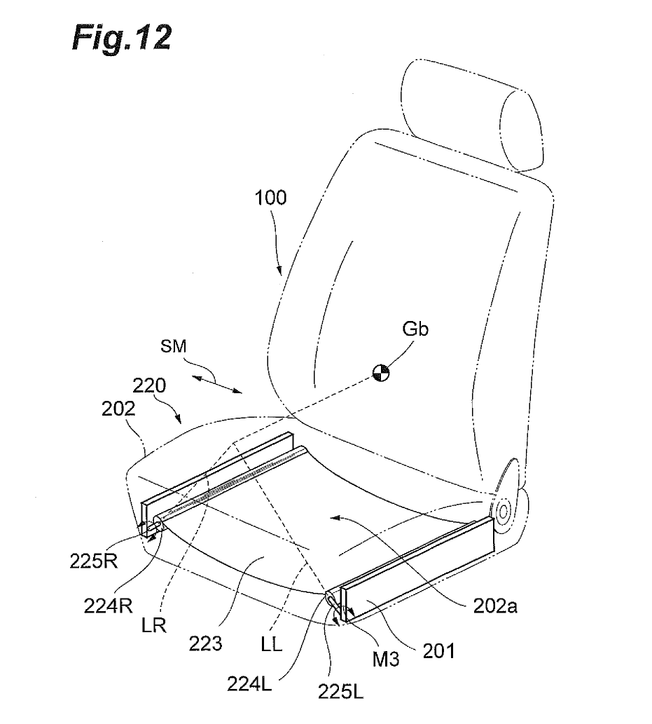

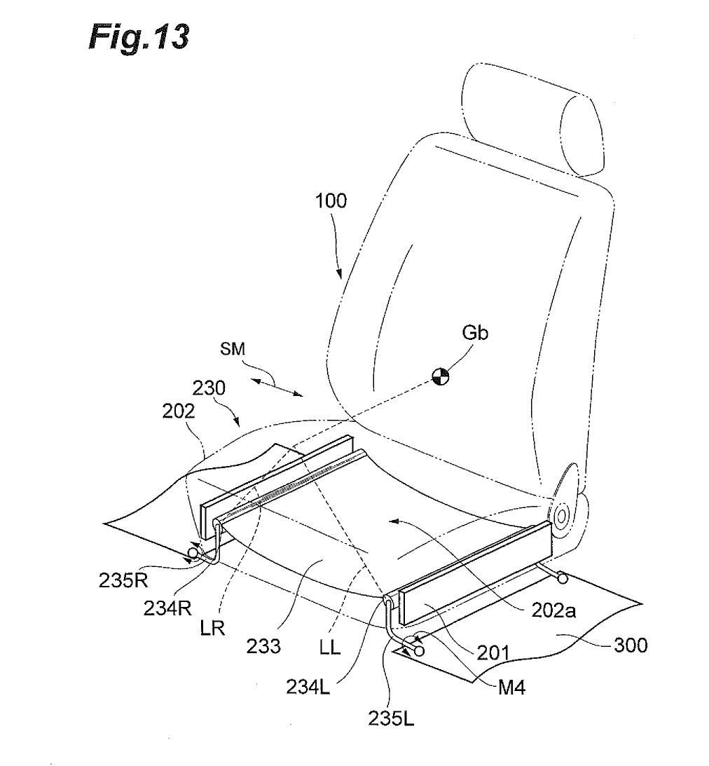

FIGS. 12 and 13 are schematic views illustrating seat portions 220 and 230 according to the second embodiment and a modification example of the second embodiment, respectively. In the seat portions 220 and 230 according to the second embodiment and the modification example of the second embodiment, right and left end portions of sitting surface portions 223 and 233 are supported in order for the sitting surface portions 223 and 233 to be able to turn in the lateral movement direction SM, that is, a direction of arrow M3. Hereinafter, the seat portion 220 according to the second embodiment will be mainly described.

As illustrated in FIG. 12, the seat portion 220 is provided with the sitting surface portion 223, a sitting surface support portion 224 (right support portion 224R and left support portion 224L), and a turning support portion 225 (right support portion 225R and left support portion 225L). The sitting surface portion 223 is a member that supports the seat cushion 202, and is provided below the flat portion 202a of the seat cushion 202. The sitting surface portion 223 may be a belt-like spring (fabric spring or the like), a wire-like spring (S spring, contour spring, or the like), or the combination thereof.

The sitting surface support portion 224 is a cylindrical or bar-shaped member that supports the sitting surface portion 223. The sitting surface support portion 224 has the right support portion 224R that supports a right end portion of the sitting surface portion 223, and the left support portion 224L that supports a left end portion of the sitting surface portion 223. The end portions of the sitting surface portion 223 may be fixed to the sitting surface support portion 224, and may have a cylindrical shape in which the sitting surface support portion 224 is inserted into each of the end portions.

The turning support portion 225 is a member by which the sitting surface support portion 224 is supported to be able to turn about the seat frame 201 or the like in the lateral movement direction SM, that is, the rolling direction of the vehicle. The turning support portion 225 has the right support portion 225R that supports the right support portion 224R of the sitting surface support portion 224, and the left support portion 225L that supports the left support portion 224L of the sitting surface support portion 224.

The turning support portion 225 supports front and rear end portions of the sitting surface support portion 224 with respect to the seat frame 201 (the floor panel 300 in the modification example illustrated in FIG. 13) and the like. The turning support portion 225 has support ends that are respectively supported by end portions of the sitting surface support portion 224, and turning ends that are supported to be able to turn with respect to the seat frame 201 (the floor panel 300 in the modification example illustrated in FIG. 13) in the direction of arrow M3 (in the direction of arrow M4 in the modification example illustrated in FIG. 13). The turning support portion 225 is supported in order for the turning ends to turn, and then return back to a position before the turning. The turning support portion 225 may turn by virtue of a mechanism (hinge or the like) of each of the support ends, or may turn by virtue of the elasticity of the turning support portion 225 (refer to FIG. 13).

Here, the seat portion 220 has the following positional relationship with respect to the occupant sitting in the seat portion 220. That is, the turning support portion 225 is configured in such a manner that the position of an imaginary turning axis substantially coincides with the height of the vicinity of the lumbar vertebra of the occupant, in which the imaginary turning axis has an axis in the rolling direction of the moving body. The imaginary turning axis is an axis obtained by connecting the intersection point between line LL and line LR, and the position Gb. Line LL extends through the support end from the turning end of the left turning support portion 225L, line LR extends through the support end from the right turning support end 225R, and the position Gb is a position obtained by projecting the intersection point to the seatback portion 100. This positional relationship is maintained even when the turning support portion 225 turns about the turning ends, and the upper body is inclined laterally. The seat portion 230 according to the modification example is also configured to have the same positional relationship.

In the seat portion 220 and 230 according to the second embodiment and the modification example of the second embodiment, the right and left end portions of the sitting surface portions 223 and 233 are supported in order for the sitting surface portions 223 and 233 to be able to turn in the lateral movement direction SM. For this reason, the sitting surface portions 223 and 233 are transformed in such a manner that the lower part of the upper body is inclined in the rolling direction of the vehicle, that is, the lateral movement direction SM.

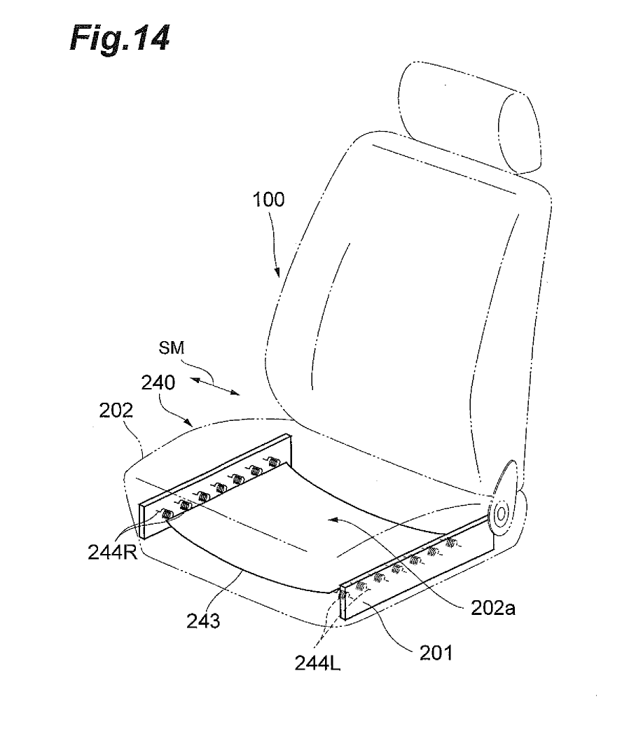

FIG. 14 is a schematic view illustrating a seat portion 240 according to the third embodiment. In the seat portion 240 according to the third embodiment, right and left end portions of the sitting surface portion 243 are elastically supported in order for the sitting surface portion 243 to be able to turn in the lateral movement direction SM.

The seat portion 240 is provided with the sitting surface portion 243 and a sitting surface support portion 244 (right support portion 244R and left support portion 244L). The sitting surface portion 243 is a member that supports the seat cushion 202, and is provided below the flat portion 202a of the seat cushion 202. The sitting surface portion 243 may be a belt-like spring (fabric spring or the like), a wire-like spring (S spring, contour spring, or the like), or the combination thereof.

The sitting surface support portion 244 is an elastic member by which the sitting surface portion 243 is supported to be able to turn about the seat frame 201. The sitting surface support portion 244 supports the sitting surface portion 243 in order for the sitting surface portion 243 to turn about the seat frame 201, and then return back to a position before the turning. The sitting surface support portion 244 has the right support portion 244R and the left support portion 244L. Here, the right support portion 244R supports a right end portion of the sitting surface portion 243 with respect to the right seat frame 201, and the left support portion 244L supports a left end portion of the sitting surface portion 243 with respect to the left seat frame 201. The sitting surface support portion 244 may be a plurality of wire-like springs or helical springs that are provided along a longitudinal direction of the seat portion 240, or may be a leaf spring that extends along right and left end portions of the seat portion 240.

In the seat portion 240 according to the third embodiment, the right and left end portions of the sitting surface portion 243 are elastically supported in order for the sitting surface portion 243 to be able to turn in the lateral movement direction SM. For this reason, the sitting surface portion 243 is transformed in such a manner that the lower part of the upper body is inclined in the rolling direction of the vehicle, that is, the lateral movement direction SM.

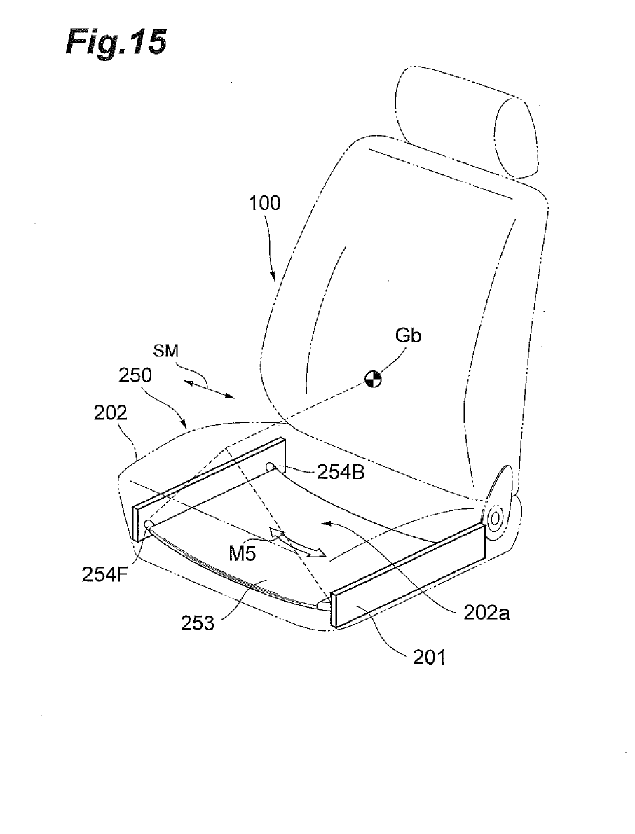

FIG. 15 is a schematic view illustrating a seat portion 250 according to the fourth embodiment. In the seat portion 250 according to the fourth embodiment, front and rear end portions of a sitting surface portion 253 are supported in order for the sitting surface portion 253 to be able to swing in the lateral movement direction SM.

The seat portion 250 is provided with the sitting surface portion 253 and a sitting surface support portion 254 (front support portion 254F and rear support portion 254B). The sitting surface portion 253 is a member that supports the seat cushion 202, and is provided below the flat portion 202a of the seat cushion 202. The sitting surface portion 253 may be a belt-like spring (fabric spring or the like), a wire-like spring (S spring, contour spring, or the like), or the combination thereof.

The sitting surface support portion 254 is a cylindrical or bar-shaped member that supports the sitting surface portion 253. Right and left end portions of the sitting surface support portion 254 are fixed to the seat frame 201. The sitting surface support portion 254 has the front support portion 254F that supports a front end portion of the sitting surface portion 253, and a rear support portion 254B that supports a rear end portion. The front support portion 254F and the rear support portion 254B are provided to have a substantially circular arc shape that is curved toward the bottom of the seat portion 250.

The sitting surface support portion 254 supports the sitting surface portion 253 along a longitudinal direction of the sitting surface portion 253 in order for the sitting surface portion 253 to be able to swing in the lateral movement direction SM, that is, the rolling direction of the vehicle. The sitting surface portion 253 swings in a direction of arrow M5 while generating frictional resistance between the sitting surface portion 253 and the sitting surface support portion 254. The seat cushion 202 supported by the sitting surface portion 253 also swings as the sitting surface portion 253 swings. The sitting surface support portion 254 may be inserted into cylindrical end portions of the sitting surface portion 253, or may be engaged with hooks (not illustrated) or the like formed in end portions of the sitting surface portion 253.

Here, the seat portion 250 has the following positional relationship with respect to the occupant sitting in the seat portion 250. That is, the sitting surface support portion 254 is configured in such a manner that the position of an imaginary turning axis substantially coincides with the height of the vicinity of the lumbar vertebra of the occupant, in which the imaginary turning axis is obtained by connecting the center of the circular arc described by the axis of the sitting surface support portion 254 and the position Gb obtained by projecting the center of the circular arc to the seatback portion 100. The positional relationship is maintained even when the sitting surface portion 253 swings, and the upper body is inclined laterally.

In the seat portion 250 according to the fourth embodiment, the front and rear end portions of the sitting surface portion 253 are supported in order for the sitting surface portion 253 to be able to swing in the lateral movement direction SM. For this reason, the sitting surface portion 253 is displaced in such a manner that the lower part of the upper body is inclined in the rolling direction of the vehicle, that is, the lateral movement direction SM.

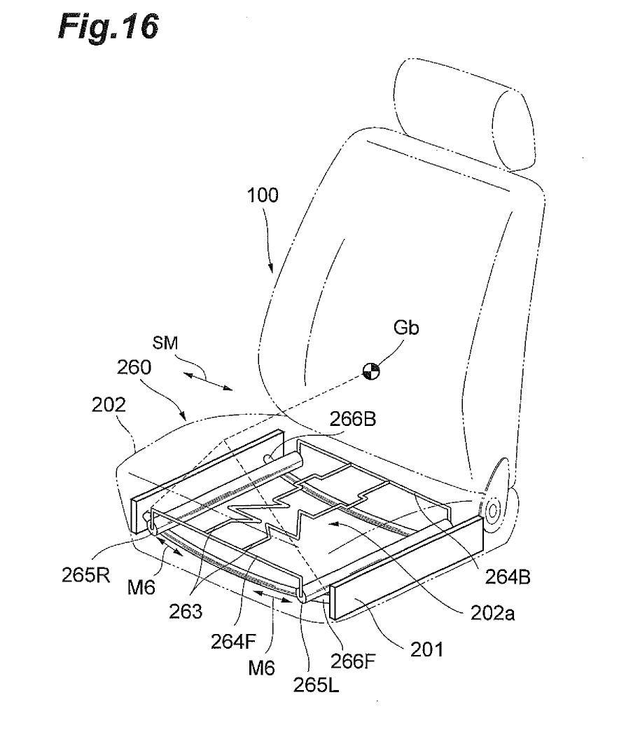

FIG. 16 is a schematic view illustrating a seat portion 260 according to the fifth embodiment. The seat portion 260 according to the fifth embodiment has a support body (sitting surface support portion 264 and roller 265) that supports a sitting surface portion 263, and a support portion (rail 266) which extends in a lateral direction of the seat portion 260 and by which the support body (the sitting surface support portion 264 and the roller 265) is supported to be able to swing in the lateral movement direction SM.

The seat portion 260 is provided with the sitting surface portion 263, the sitting surface support portion 264 (front support portion 264F and rear support portion 264B), the roller 265 (right roller 265R and left roller 265L), and the rail 266 (front rail 266F and rear rail 266B). The sitting surface support portion 264 and the roller 265 function as support bodies that support the sitting surface portion 263.

The sitting surface portion 263 is a member that supports the seat cushion 202, and is provided below the flat portion 202a of the seat cushion 202. The sitting surface portion 263 may be a belt-like spring (fabric spring or the like), a wire-like spring (S spring, contour spring, or the like), or may be the combination thereof. In the example illustrated in FIG. 16, the sitting surface portion 263 is illustrated as two pieces of S springs that extend in a longitudinal direction of the seat portion 260.

The sitting surface support portion 264 is a rigid member that supports front and rear end portions of the sitting surface portion 263. The sitting surface support portion 264 has the front support portion 264F that supports the front end portions of the sitting surface portion 263, and the rear support portion 264B that supports the rear end portions of the sitting surface portion 263. It is preferable that the sitting surface support portion 264 can support the sitting surface portion 263 with respect to the roller 265, and for example, the sitting surface support portion 264 may support right and left sides or the surroundings of the sitting surface portion.

The roller 265 is a cylindrical or round bar-shaped member that supports the sitting surface support portion 264. The roller 265 has the right roller 265R that supports right end portions of the sitting surface support portion 264, and the left roller 265L that supports left end portions of the sitting surface support portion 264. A front end portion of the left roller 265L supports the left end portion of the front support portion 264F of the sitting surface support portion 264, and a rear end portion of the left roller 265L supports the left end portion of the rear support portion 264B of the sitting surface support portion 264. Similarly, a front end portion of the right roller 265R supports the right end portion of the front support portion 264F of the sitting surface support portion 264, and a rear end portion of the right roller 265R supports the right end portion of the rear support portion 264B of the sitting surface support portion 264.

The rail 266 is a support member that has a circular arc surface and supports the roller 265. The rail 266 extends in the lateral direction of the seat portion 260, and the sitting surface support portion 264 and the roller 265 are supported so as to be able to swing in the lateral movement direction by the rail 266. Right and left end portions of the rail 266 are fixed to the seat frame 201. In the example illustrated in FIG. 16, the front rail 266F and the rear rail 266B of the rail 266 are illustrated, the front rail 266F extends along a front end of the seat portion 260, and the rear rail 266B extends along a rear end of the seat portion 260. However, it is preferable that the roller 265 is supported to be able to swing by the rail 266, and for example, the front and rear rails may be integrally formed.

The rail 266 extends in the lateral direction of the seat portion 260, and has a substantially circular arc shape that is curved toward the bottom of the seat portion 260. The rail 266 supports the roller 265 and the like in order for the sitting surface portion 263 to be able to swing along the axis of the rail 266 in the lateral direction of the seat portion 260. The rollers 265R and 265L swing in the direction of arrow M6 while generating frictional resistance between the rollers 265R and 265L and the rails 266F and 266B. The sitting surface portion 263 and the seat cushion 202 supported by the rollers 265R and 265L and the like also swing as the rollers 265R and 265L swing.

Here, the seat portion 260 has the following positional relationship with respect to the occupant sitting in the seat portion 260. That is, the rail 266 is configured in such a manner that the position of an imaginary turning axis substantially coincides with the height of the vicinity of the lumbar vertebra of the occupant, in which the imaginary turning axis is obtained by connecting the center of the circular arc described by the axis of the rail 266 and the position Gb obtained by projecting the center of the circular arc to the seatback portion 100. The positional relationship is maintained even when the sitting surface portion 263 swings with respect to the rails 266F and 266B, and the upper body is inclined laterally.

The seat portion 260 according to the fifth embodiment has the support body (the sitting surface support portion 264 and the roller 265) that supports the sitting surface portion 263, and the support body (the rail 266) which extends in the lateral direction of the seat portion 260 and by which the support body (the sitting surface support portion 264 and the roller 265) is supported to be able to swing in the lateral movement direction SM. For this reason, the sitting surface portion 263 is displaced in order for the lower part of the upper body to be inclined in the rolling direction of the vehicle, that is, the lateral movement direction SM.

As described above, in the seat portions 210, 220, 230, 240, 250, and 260 according to the embodiments of the present invention, when the upper body moves laterally, the sitting surface portions 213, 223, 233, 243, 253, and 263 are respectively transformed or displaced in such a manner that the lower part of the upper body is inclined in the lateral movement direction SM. When the lower part of the upper body is inclined, contrary to the inclination, the upper part of the upper body is naturally inclined toward the opposite direction of the lateral movement direction SM. As a result, the upper body is naturally pushed against the upper portion 100U of the seatback portion 100, and it is possible to effectively prevent the rolling of the upper body. In particular, since the upper part of the upper body is inclined toward the opposite direction of the lateral movement direction SM, it is possible to effectively prevent the rolling of the head part of the occupant, and prevent the occurrence of carsickness symptoms or the like.

The preferred embodiments of the seat for a moving body according to the present invention are described above, however, the seat for a moving body according to the present invention is not limited to the embodiments. Modification may be made to the seat for a moving body according to the present invention insofar as the modifications do not depart from the spirit of the present invention disclosed in each of the claims, and the seat for a moving body according to the present invention may be applied to a seat for other moving bodies.

### REFERENCE SIGNS LIST

100, 110, 120, 130, 140, 150, 160, 170, 180: seatback portion
100U, 110U, 120U, 130U, 140U, 150U, 160U, 170U, 180U: upper portion of seatback portion
100L, 110L, 120L, 130L, 140L, 150L, 160L, 170L, 180L: lower portion of seatback portion
101: seatback frame
102: seatback cushion
201: seat frame
102: seat cushion
200, 210, 220, 230, 240, 250, 260: seat portion
203, 213, 223, 233, 243, 253, 263: sitting surface portion

1. A seat for a moving body comprising:
a backrest portion; and
a seat portion,
wherein the backrest portion includes a lower backrest portion that supports a lower part of the upper body of an occupant sitting in the seat portion, and an upper backrest portion that supports an upper part of the upper body, and
wherein the lower backrest portion has support resistance against the lateral movement of the upper body, which is lower than that of the upper backrest portion, and
wherein the seat portion has a sitting surface portion that is transformed or displaced in such a manner that the lower part of the upper body is inclined to be low in a lateral movement direction and to be high in an opposite direction of the lateral movement direction, when the upper body moves laterally.

2. (canceled)

3. The seat for a moving body according to claim 1,
wherein the sitting surface portion is transformed or displaced about an imaginary turning axis that is positioned at the height of the lower part of the upper body and has an axis in a rolling direction of the moving body.

4. The seat for a moving body according to claim 1,
wherein the lower backrest portion has a cushion portion formed by a plurality of block members that line up at least in the lateral movement direction while being separate from each other.

5. The seat for a moving body according to claim 1,
wherein the lower backrest portion has a cushion portion in which gaps are formed in a direction intersecting the lateral movement direction.

6. The seat for a moving body according to claim 1,
wherein the lower backrest portion is made of a material having resistance against transformation associated with the lateral movement, which is lower than that of the upper backrest portion.

7. The seat for a moving body according to claim 1,
wherein each of the upper and lower backrest portions has a plurality of air cushions, and
wherein the air cushions of the upper backrest portion line up in a direction intersecting the lateral movement direction, and the air cushions of the lower backrest portion line up to be parallel with each other in the lateral movement direction.

8. The seat for a moving body according to claim 1,
wherein each of the upper and lower backrest portions has a surface fabric, and
wherein the surface fabric of the upper backrest portion is stitched to have seams formed in a direction intersecting the lateral movement direction, and the surface fabric of the lower backrest portion is stitched to have seams formed in parallel with the lateral movement direction.

9. The seat for a moving body according to claim 1,
wherein the lower backrest portion has a cushion portion that is supported to have mobility in the lateral movement direction, which is greater than that of a cushion portion of the upper backrest portion.

10. The seat for a moving body according to claim 1,
wherein the seat portion has a support body that has right and left end portions and supports the sitting surface portion, and a turning support portion, one end of which is supported to be able to turn about a support end positioned above each of the right and left end portions, and the other end of which is supported to be able to turn about each of the end portions.

11. The seat for a moving body according to claim 1,
wherein right and left end portions of the sitting surface portion are supported in order for the sitting surface portion to be able to turn in the lateral movement direction.

12. The seat for a moving body according to claim 1,
wherein right and left end portions of the sitting surface portion are elastically supported in order for the sitting surface portion to be able to turn in the lateral movement direction.

13. The seat for a moving body according to claim 1,
wherein front and rear end portions of the sitting surface portion are supported in order for the sitting surface portion to be able to swing in the lateral movement direction.

14. The seat for a moving body according to claim 1,
wherein the seat portion has a support body that supports the sitting surface portion, and a support portion which extends in a lateral direction of the seat portion and by which the support body is supported to be able to swing in the lateral movement direction.

15. A seat for a vehicle comprising:
a backrest portion; and
a seat portion,
wherein the backrest portion includes a lower backrest portion that supports a lower part of the upper body of an occupant sitting in the seat portion, and an upper backrest portion that supports an upper part of the upper body, and
wherein the lower backrest portion has support resistance against the lateral movement of the upper body, which is lower than that of the upper backrest portion, and
wherein the seat portion has a sitting surface portion that is transformed or displaced in such a manner that the lower part of the upper body is inclined to be low in a lateral movement direction and to be high in an opposite direction of the lateral movement direction, when the upper body moves laterally.
